(19) United States
(12) Patent Application Publication
(10) Pub. No.: US 2014/0359780 A1
(43) Pub. Date: Dec. 4, 2014

(54) ANTI-CYBER ATTACKS CONTROL VECTORS

(71) Applicant: CYTEGIC LTD., Rehovot (IL)

(72) Inventors: Shay Zandani, Rehovot (IL); Elon Kaplan, Ramat Hasharon (IL)

(73) Assignee: CYTEGIC LTD.

(21) Appl. No.: 14/287,371

(22) Filed: May 27, 2014

Related U.S. Application Data
(60) Provisional application No. 61/828,347, filed on May 29, 2013.

(51) Int. Cl. H04L 29/06

(52) U.S. Cl. CPC H04L 63/1433
USPC 726/25

(57) ABSTRACT

A method for calculating an effectiveness of anti-cyber attack controls, the method comprising using at least one hardware processor for: providing a matrix of attack method and technology layer pairs; providing anti-attack effectiveness values for a plurality of controls against the attack method and technology layer pairs; composing control groups each comprising multiple ones of said plurality of controls having the highest anti-attack effectiveness values; deriving control vectors from said control groups, said deriving being based on a regression analysis of all possible orders of controls in each one of said control groups; and displaying an effectiveness measure of at least some of the plurality of controls, based on the control vectors.

### FIELD OF THE INVENTION

The invention relates to anti-cyber attack control vectors.

### BACKGROUND

The proliferation of networked computers using a network (e.g. Internet) has grown exponentially in recent years. In addition, many local or enterprise networks have connectivity to a network via a gateway, so that all computers on a business' local network are also accessible to a network. Other forms of access, including wireless devices, allowing access to a local or enterprise network, as well as directly to a network are common. In short, network connectivity of computers is quite common. It is also well known that networked computer may be susceptible to online cyber attacks. Such cyber attacks are typically attempts to obtain control or information from the target computer system. A common form of information is data stored pertaining to personal and financial data, however hackers or intruders will attempt to obtain any information regarding the target computer system, such as passwords, email addresses, program names, etc. in an attempt to further their illegal goals.

As a result, the need of cyber attack management is also on the rise. This management includes assessing, measuring and decision making regarding cyber attacks and relevant controls.

U.S. Pat. No. 8,266,701 to McConnell et al. discloses a method and system are disclosed for assessing cyber-based risks in an enterprise organization. A database comprising vulnerability data associated with computers in an enterprise is combined with a second database comprising data of users of computers in an enterprise, along with a third database base indicating the relationship of the users in an organization structure in the enterprise. From the synthesis of data in these separate databases, text based reports detailing aggregate computer vulnerabilities can be produced on a computer, as well as organizational chart depicting the relationship between selected individuals and their computer vulnerabilities. Using such reports, individuals charged with cyber-security can assess organizational cyber risks and allocate resources as appropriate.

U.S. Patent Application Publication No. 2010/0153156 to Guinta et al. discloses a method and apparatus for computer-aided assessment of risk, criticality, and vulnerability with respect to a site. The method and apparatus may use multiple factors to determine overall risk. In some embodiments, the method may assess or determine an impact if a site or asset is lost. The method and apparatus may identify and quantify what risks are acceptable and unacceptable. In an embodiment, a method and apparatus may incorporate mathematical evaluations and numeric assignments that result in a criticality vector and a vulnerability vector. In some embodiments, the criticality vector and vulnerability vector may be used to represent a site's overall risk and/or prioritization and ranking relative to other sites.

U.S. Patent Application Publication No. 2012/0233698 to Watters et al. discloses a security system. The system comprises a computer system, a memory accessible to the computer system, a data store, and an application. The data store comprises a threat catalog, wherein the threat catalog comprises a plurality of threat vectors, each threat vector comprising a plurality of fields, wherein each field is constrained to carry a value selected from a predefined list of enumerated values. The application is stored in the memory and, when executed by the computer system receives a threat report, wherein the threat report comprises an identification of at least one threat vector, determines a correlation between the at least one threat vector received in the threat report with the threat vectors comprising the threat catalog, and, based on the correlation, sends a notification to a stakeholder in an organization under the protection of the security system.

U.S. Patent Application Publication No. 2013/0055404 to Khalili discloses a system and method to provide impact modeling and prediction of attacks on cyber targets (IMPACT). An embodiment of the system and method creates a network model to describe the IT resources of an organization, creates a business model to describe the origination's mission, and creates a correlation model that correlates the network model and the business model to describe how the origination's mission relies on the IT resources. Proper analysis may show which cyber resources are of tactical importance in a cyber attack. Such analysis also reveals which IT resources contribute most to the organization's mission. These results may then be used to formulate IT security strategies and explore their trade-offs, which leads to better incident response.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for calculating an effectiveness of anti-cyber attack controls, the method comprising using at least one hardware processor for: providing a matrix of attack method and technology layer pairs; providing anti-attack effectiveness values for a plurality of controls against the attack method and technology layer pairs; composing control groups each comprising multiple ones of said plurality of controls having the highest anti-attack effectiveness values; deriving control vectors from said control groups, said deriving being based on a regression analysis of all possible orders of controls in each one of said control groups; and displaying an effectiveness measure of at least some of the plurality of controls, based on the control vectors.

There is further provided, in accordance with an embodiment, a non-transitory computer readable storage medium having computer-readable code stored thereon, which, when executed by at least one hardware processor, causes said at least one hardware processor to: provide a matrix of attack method and technology pairs; provide anti-attack effectiveness values for a plurality of controls against the attack method and technology layer pairs; compose control groups each comprising multiple ones of said plurality of controls having the highest anti-attack effectiveness values; derive control vectors from said control groups, said derive being based on a regression analysis of all possible orders of controls in each one of said control groups; and display an effectiveness measure of at least some of the plurality of controls, based on the control vectors.

In some embodiments, said plurality of controls comprise major controls and supportive controls, said supportive controls are intended to enhance an ability of said major controls to stop attacks.

In some embodiments, said providing of the matrix comprises analyzing and categorizing attack methods to technology layers in which the attack methods are applicable.

In some embodiments, said providing of the matrix of comprises calculating required attacker skills and resources for each of said pairs.

In some embodiments, said providing of the matrix comprises analyzing possible movements between cells of said matrix.

In some embodiments, said providing of the anti-attack effectiveness values comprises analyzing data produced by attacks against at least some of the plurality of controls.

In some embodiments, said providing of the anti-attack effectiveness values comprises analyzing data produced by simulations of attacks against at least some of the plurality of controls.

In some embodiments, said analyzing of data is performed by identifying key elements, said key elements comprising attack, asset, outcome, timing, and reported defenses.

In some embodiments, said providing of the anti-attack effectiveness values comprises assessing an ability of each of said controls to stop said attack methods.

In some embodiments, said composing of control groups is performed using stepwise regression analysis.

In some embodiments, said stepwise regression analysis enables correlation equivalence of a relationship between specific controls and attacks.

In some embodiments, said deriving of control vectors further comprises a regression analysis of all possible quantities of controls in each one of said control groups.

In some embodiments, each of said control vectors comprises a major control and one or more successive controls, each one of said controls is weighted according to its partial correlation with the corresponding attack method-technology layer pair.

In some embodiments, said deriving of control vectors further comprises calculating of actual effectiveness for each of said control vectors.

In some embodiments, said actual effectiveness is calculated using the maturity of said controls within an assessed environment.

In some embodiments, the method further comprises automatically implementing one or more changes in a security policy of an organization, wherein: the security policy pertains to the anti-cyber attack controls employed by the organization; and said implementing is based on the control vectors.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a schematic illustration of a cyber attack, in accordance with some embodiments; and

FIG. 2 shows a flowchart of calculating effectiveness of anti-cyber attack controls, in accordance with some embodiments.

### DETAILED DESCRIPTION

Disclosed herein is a method for calculating the effectiveness of anti-cyber attack control means (hereinafter “controls”). The method may firstly provide a matrix of attack method and technology pairs, by analyzing the environment of the organization. Then, a suitable control may be provided for each pair, with an effectiveness value. The controls may be divided to groups having the highest anti-attack effectiveness values. Finally, control vectors may be derived based on a regression analysis of all possible orders of controls in the control groups. The final result may imply of which control is effective and which is not, for a certain organizational environment.

Since anti-cyber attack controls generally require considerable organizational resources such as management attention, time, money etc., a method which allows managers to comprehend and assess the marginal contribution of each control, and thus reduce/increase its usage, may be highly advantageous.

### Glossary

Attack method: an abstract type of cyber attack that is available to an attacker, if that attacker has the required skills and resources. An attack method is defined by applicability to various technology layers, and required skills and resources to carry out the attack against the technology layer. For example: resource depletion, abuse of functionality, social engineering, abuse of authentication, etc.

Asset: an abstract object, technology or process that is the ultimate target of a cyber attack. An asset may potentially instantiate in any technology layer. For example, a bank's e-banking website is a specific instance of the abstract “Transaction Web Application” asset at the network and application and human technology layers.

Technology layer: refers to pre-defined common layers at which attackers and controls operate. For example, the ISO 7498-1 OSI model differentiates between the network layer and the application layer, and different attack methods instantiate differently at those layers, as well as different technological and process Security controls that operate at those layers.

Control: technical, process and human countermeasures intended to protect the assets of an organization from cyber attacks. Examples: firewalls, anti-virus software, information security policies, awareness and training, data leakage prevention. Major controls are the leading controls within an environment, and supportive controls enhance major controls ability to stop attacks or increase the resilience of the environment. An example for a major control is Secure Development Framework, and its supportive controls could be in a specific Control Group—SAST (Static Application Software Testing), penetration testing and DAST (Dynamic Application Software Testing).

Control group: a group of one or more controls, derived from a stepwise regression analysis to fit a certain attack method-technology layer pair.

Control vector: a structure of controls attributed to a certain control group, wherein the controls are ordered by contribution to effectiveness. Multiple control vectors per one control group may exist.

Potential effectiveness: the percentage of attacks stopped by a certain control at an optimal configuration state and without interference from additional controls (or through purging the data from interference). The additional effectiveness of supportive controls may be assessed in the same way.

Actual effectiveness: the potential effectiveness of a certain control, factored with the maturity of the control. It may be calculated for each control vector.

Unless specifically stated otherwise, as apparent from the following discussions, it is appreciated that throughout the specification discussions utilizing terms such as “processing”, “computing”, “calculating”, “determining”, or the like, refer to the action and/or process of a computing system or a similar electronic computing device, that manipulate and/or transform data represented as physical, such as electronic, quantities within the computing system's registers and/or memories into other data similarly represented as physical quantities within the computing system's memories, registers or other such.

Some embodiments may be implemented, for example, using a computer-readable medium or article which may store an instruction or a set of instructions that, if executed by a computer (for example, by a hardware processor and/or by other suitable machines), cause the computer to perform a method and/or operations in accordance with embodiments of the invention. Such a computer may include, for example, any suitable processing platform, computing platform, computing device, processing device, computing system, processing system, computer, processor, gaming console or the like, and may be implemented using any suitable combination of hardware and/or software. The computer-readable medium or article may include, for example, any type of disk including floppy disks, optical disks, CD-ROMs, magnetic-optical disks, read-only memories (ROMs), random access memories (RAMs), flash memories, electrically programmable read-only memories (EPROMs), electrically erasable and programmable read only memories (EEPROMs), magnetic or optical cards, or any other type of media suitable for storing electronic instructions, and capable of being coupled to a computer system bus.

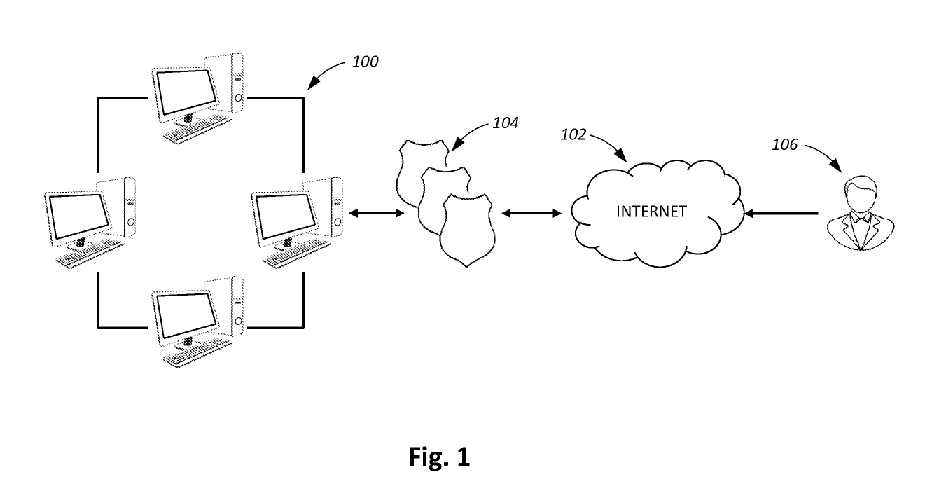

The present disclosure may be better understood with reference to the accompanying figures. Reference is now made to FIG. 1, which shows a schematic illustration of a cyber attack. An organizational computer network 100 may be connected to an external network (e.g. the Internet) 102 via organizational defense layers 104. Defense layers 104 may be intended to protect computer network 100 from cyber attacks initiated by an attacker 106, who may try to access computer network 100 via the Internet 102.

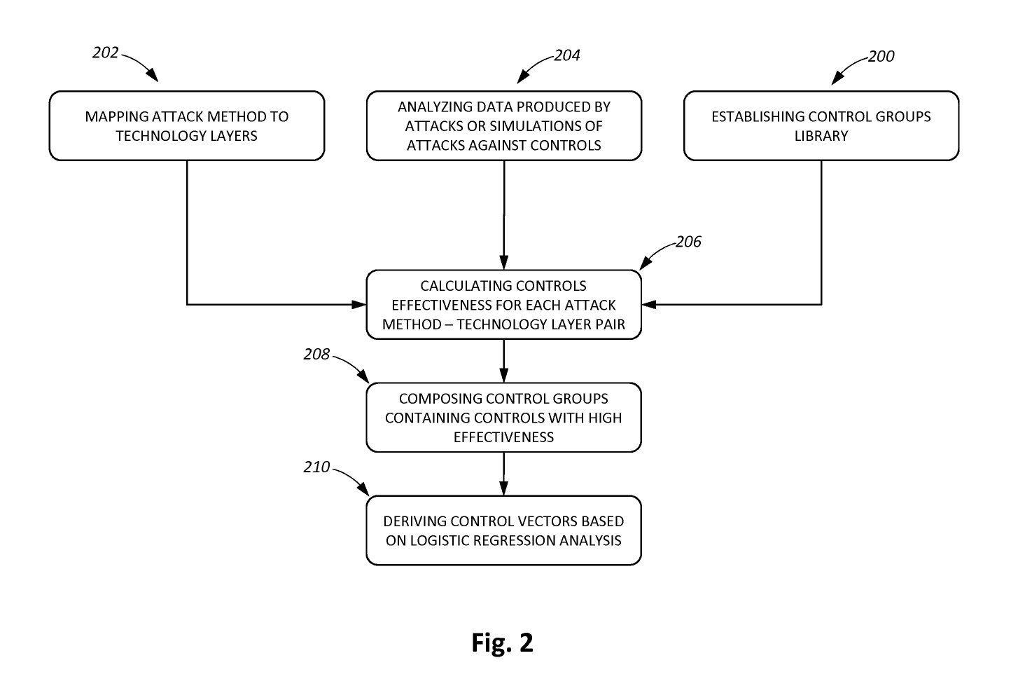

Reference is now made to FIG. 2, which shows a flowchart of calculating the effectiveness of anti-cyber attack controls. The process may start with establishing a potential control groups library 200, which may be derived centrally for all organizations. Security controls may be first pre-defined as major controls or supportive controls, the last being controls that enhance the major controls' ability to stop attacks, or increase the resilience of the environment as a whole. Another important phase may be mapping attack methods to technology layers 202, in which attack methods may be analyzed and categorized to technology layer in which they may be applicable, and required attacker skills and resources may be calculated for each. A result of this phase may be a matrix of attack method—technology layer pairs, wherein required attacker skills and resources may be determined for each pair. An example of such table may be as the following:

| | | Technology layer (e.g. network layer) | | | | | | |
|---|---|---|---|---|---|---|---|---|
| | | 1 | 2 | 3 | 4 | 5 | 6 | 7 |
| Attack method | 1 | Sk.: | N/A | Sk. | Sk. | Sk. | N/A | Sk. |
| (e.g. resource | | minimal | | Res. | Res. | Res. | | Res. |
| depletion) | | Res.: | | | | | | |
| | | minimal | | | | | | |
| | 2 | Sk. | Sk. | N/A | Sk. | Sk. | Sk. | Sk. |
| | | Res. | Res. | | Res. | Res. | Res. | Res. |
| | 3 | Sk. | N/A | Sk. | Sk. | Sk. | Sk. | Sk. |
| | | Res. | | Res. | Res. | Res. | Res. | Res. |
| | 4 | Sk. | Sk. | N/A | N/A | Sk. | Sk. | Sk. |
| | | Res. | Res. | | | Res. | Res. | Res. |
| | 5 | Sk. | N/A | Sk. | Sk. | Sk. | N/A | Sk. |
| | | Res. | | Res. | Res. | Res. | | Res. |
| | 6 | N/A | Sk. | Sk. | Sk. | N/A | Sk. | Sk. |
| | | | Res. | Res. | Res. | | Res. | Res. |

Wherein Sk. = Skills, Res. = Resources, and N/A = Not Applicable.

An analysis of possible movements between cells may be also done. The available movements may be dependent on characteristics of the assessed environment. For example, it may not be possible to move from resource depletion—network layer attack to an abuse of authentication—application layer attack, since a successful resource depletion attack would render the application layer unavailable.

In order to make the process effective, analyzing data produced by attacks or simulations of attacks against certain controls 204 may be performed. For the purpose of this analysis, huge amounts of relevant data may be collected. Feeds may be analyzed to identify key elements such as type of attack, asset, outcome, timing, reported defenses and more. A set of indices may enable continuous independent data gathering and indexing process while addressing a variety of scenarios. A critical integration function may be the time-series analysis of gathered data. For example, a report of successful penetration may be often reported long after the actual event occurred. Matching data time-wise may enable correlating attack, defense & outcome but only in hindsight. Therefore the automatic analytical process may follow the following steps: intake of data from data sources by XML, API or any relevant interface and storage of this data in accessible format; semantic engine content analysis of captured records and generation of reference indices based on the taxonomy algorithm; and time-wise correlation of stored pieces of data to generate a virtual flat representation of events including the characteristics of the attack, defenses, technological environment & outcomes. Some data sources, such as clients, may represent data closer in structure to the virtual flat representation, and thus may enable instant integration eliminating the need for semantic analysis. Predictive components may use analytical tools such as trends analysis, factor analysis and pattern recognition to generate hypothesized relationships between attacks, defenses, technology and outcome thus creating suggested models. Confirmatory component may utilize path analysis technique to estimate the goodness-of-fit of the predicted models to gathered data. By comparing the outcomes of trends analysis on one hand and goodness-of-fit on the other, amended weights and formulas may be generated, constantly maintaining adequate computations representing current threats and relevant reactions.

In the next phase of the process, each attack method—technology layer pair may be assessed against the pre-defined list of major security controls, to determine the anti-attack potential effectiveness of each control 206 regarding stopping or mitigating that specific attack. Not all controls may be assessed, their relevance to a given attack method —technology layer pair having been pre-defined.

Once potential effectiveness of major and supportive controls may be assessed against attack method—technology layer pairs, specific control groups may be generated 208, containing the controls having the highest anti-attack effectiveness values, using stepwise regression analysis of the large data samples. This method may permit assumption of a normal continuous binary curve, thus enabling not only correlation equivalence of relationship between specific controls and attacks, but also instances of multiple controls. For example, as a high level explanation, a given pair of attack method and technology represents the total exposure to the organization in that space. Several controls may claim to limit such exposure to a certain degree. In our example, control A claims to limit 70%, control B 60% and control C 50%. Theoretically, we have covered more than 100%, however, control A and B overlap in 90% between them, and control A and C overlap in 30% between them. Based on partial correlations, the marginal contribution of control C is higher than the marginal contribution on control B. In this case—control A contributes 70% as the major control, B and C (as supportive controls) contribute 2% and 11%, respectively. Review of the added defensive power of specific controls in the stepwise regression model may determine the order of controls in the control group as well as their weight in the equation.

The final phase in the process may involve derivation of multiple control vectors per control group 210, wherein different contributions to effectiveness of the different controls may be calculated based on the order of calculation and the residual defensive power of each successive control after the major control. For each control vector, the first major control may contribute its whole potential effectiveness and each successive control's contribution may be calculated as a regression model achieved in a stepwise method, where each element in the equation may be weighted according to the partial correlation it has with the target.

The final results may be all possible potential control vectors for each possible attack method—technology layer pair. The potential control vectors may then be passed to decision support systems, in which they may be assessed against the actual maturity of the controls within the assessed environment. For each potential control vector, an actual effectiveness against the attack method at the technological layer may be calculated. Moreover, effectiveness results may be displayed to the enterprise management, in order to support of making decision regarding the controls (increasing or decreasing instances of a certain control, etc.).

Depending on the capabilities of the organization's cyber command and control IT systems, control vectors may be used to automatically initiate triggers in these systems to activate remediation and/or prevention activities, ranging from alerts to actively implementing changes in the security policy of the organization, for example—separating segments of the organizational network by sending commands to the relevant routers, updating the anti-virus version, and/or adding new rules to the firewall rule base.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

What is claimed is:

1. A method for calculating an effectiveness of anti-cyber attack controls, the method comprising using at least one hardware processor for:
providing a matrix of attack method and technology layer pairs;
providing anti-attack effectiveness values for a plurality of controls against the attack method and technology layer pairs;
composing control groups each comprising multiple ones of said plurality of controls having the highest anti-attack effectiveness values;
deriving control vectors from said control groups, said deriving being based on a regression analysis of all possible orders of controls in each one of said control groups; and
displaying an effectiveness measure of at least some of the plurality of controls, based on the control vectors.

2. The method according to claim 1, wherein said plurality of controls comprise major controls and supportive controls, said supportive controls are intended to enhance an ability of said major controls to stop attacks.

3. The method according to claim 1, wherein said providing of the matrix comprises analyzing and categorizing attack methods to technology layers in which the attack methods are applicable.

4. The method according to claim 1, wherein said providing of the matrix of comprises calculating required attacker skills and resources for each of said pairs.

5. The method according to claim 1, wherein said providing of the matrix comprises analyzing possible movements between cells of said matrix.

6. The method according to claim 1, wherein said providing of the anti-attack effectiveness values comprises analyzing data produced by attacks against at least some of the plurality of controls.

7. The method according to claim 1, wherein said providing of the anti-attack effectiveness values comprises analyzing data produced by simulations of attacks against at least some of the plurality of controls.

8. The method according to claim 6, wherein said analyzing of data is performed by identifying key elements, said key elements comprising attack, asset, outcome, timing, and reported defenses.

9. The method according to claim 7, wherein said analyzing of data is performed by identifying key elements, said key elements comprising attack, asset, outcome, timing, and reported defenses.

10. The method according to claim 1, wherein said providing of the anti-attack effectiveness values comprises assessing an ability of each of said controls to stop said attack methods.

11. The method according to claim 1, wherein said composing of control groups is performed using stepwise regression analysis.

12. The method according to claim 11, wherein said stepwise regression analysis enables correlation equivalence of a relationship between specific controls and attacks.

13. The method according to claim 1, wherein said deriving of control vectors further comprises a regression analysis of all possible quantities of controls in each one of said control groups.

14. The method according to claim 1, wherein each of said control vectors comprises a major control and one or more successive controls, each one of said controls is weighted according to its partial correlation with the corresponding attack method-technology layer pair.

15. The method according to claim 1, wherein said deriving of control vectors further comprises calculating of actual effectiveness for each of said control vectors.

16. The method according to claim 15, wherein said actual effectiveness is calculated using the maturity of said controls within an assessed environment.

17. The method according to claim 1, further comprising automatically implementing one or more changes in a security policy of an organization, wherein:
the security policy pertains to the anti-cyber attack controls employed by the organization; and
said implementing is based on the control vectors.

18. A non-transitory computer readable storage medium having computer-readable code stored thereon, which, when executed by at least one hardware processor, causes said at least one hardware processor to:
provide a matrix of attack method and technology pairs;
provide anti-attack effectiveness values for a plurality of controls against the attack method and technology layer pairs;
compose control groups each comprising multiple ones of said plurality of controls having the highest anti-attack effectiveness values;
derive control vectors from said control groups, said derive being based on a regression analysis of all possible orders of controls in each one of said control groups; and
display an effectiveness measure of at least some of the plurality of controls, based on the control vectors.

19. The non-transitory computer readable storage medium according to claim 18, wherein said plurality of controls comprise major controls and supportive controls, said supportive controls are intended to enhance an ability of said major controls to stop attacks.

20. The non-transitory computer readable storage medium according to claim 18, wherein said providing of the matrix comprises analyzing and categorizing attack methods to technology layers in which the attack methods are applicable.
